(19) United States
(12) Patent Application Publication
(10) Pub. No.: US 2026/0170353 A1
(43) Pub. Date: Jun. 18, 2026

(54) GENETIC ALGORITHM-BASED GENERATIVE LEARNING SYSTEM FOR SYNTHETIC TEXT GENERATION

(71) Applicant: Optum, Inc., Minnetonka, MN (US)

(72) Inventors: Rahul Bhaskar, Irvine, CA (US); Rahul Pathak, Gorakhpur (IN); Reema Sharma, Noida (IN); Anushree Jain, Noida (IN); Mohit Singhal, Delhi (IN); Amardeep Sharma, Delhi (IN); Vaibhav Kakkar, Irvine, CA (US)

(21) Appl. No.: 18/985,927

(22) Filed: Dec. 18, 2024

(51) Int. Cl. G06N 3/126

(52) U.S. Cl. CPC G06N 3/126

(57) ABSTRACT

Various embodiments of the present disclosure provide a genetic algorithm-based generative learning system for synthetic text generation that comprises generating using an encoder of a generative machine learning model, a sample text embedding of a corpus sample; generating using a decoder of the generative machine learning model, a synthetic sample based on the sample text embedding of the corpus sample; generating using the encoder, a synthetic text embedding of the synthetic sample; generating using a cost function, a similarity measure for the synthetic sample based on a first comparison between the synthetic text embedding and the sample text embedding; generating using the cost function, a variation measure for the synthetic sample based on a second comparison between the synthetic text embedding and the sample text embedding; and providing a model performance score for the generative machine learning model based on a comparison between the similarity measure and the variation measure.

### BACKGROUND

In the field of machine learning and artificial intelligence, the ability to provide diverse and contextually appropriate text samples may be important for training machine learning models and improving performance on various classification and/or natural language processing (NLP) tasks, such as sentiment analysis. Synthetic samples may be generated to improve the quality of existing, real-world data, to improve the diversity, breadth, and scope of use cases for a machine learning model. However, generating synthetic samples presents significant challenges, particularly in maintaining statistical and semantic similarity to original data while introducing sufficient variability. Existing approaches to synthetic text generation often struggle to balance similarity and diversity, leading to samples that may not accurately represent the complexity and nuances of natural language. Various embodiments of the present disclosure make important contributions to synthetic text generation technologies by addressing these technical challenges, among others.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of example synthetic training data generation approach in accordance with some embodiments of the present disclosure.

FIG. 5 depicts an operational example of a genetic algorithm-based generative learning framework in accordance with some embodiments of the present disclosure.

FIG. 6 depicts a flowchart diagram of an example genetic algorithm-based generative learning process in accordance with some embodiments of the present disclosure.

FIG. 7 depicts a flowchart diagram of an example generative learning evaluation process in accordance with some embodiments of the present disclosure.

FIG. 8 depicts a flowchart diagram of an example training data generation process in accordance with some embodiments of the present disclosure.

### DETAILED DESCRIPTION

Various embodiments of the present disclosure provide machine learning architectures and training techniques that improve the functionality of a computer with respect to machine learning tasks, including synthetic data generation, machine learning training, among others that lead to several technical improvements in various computing fields. More particularly, some embodiments of the present disclosure provide improved synthetic data generation techniques and generative machine learning techniques that combine a generative machine learning model with a genetic algorithm-based approach to expand a training data for downstream training tasks. The genetic algorithm-based approach may comprise a cost function that is used to generate feedback representative of the performance of the generative machine learning model in generating synthetic outputs that expand the variability of the training data (e.g., to improve the scope of a downstream model) without diverging from an underlying data distribution (e.g., to maintain/improve an accuracy of the model with respect to the expanded scope). In this way, the synthetic data generation and generative machine learning techniques of the present disclosure may directly address challenges in generating synthetic data. For instance, by applying a cost function that balances statistical and semantic similarity with output variability, the techniques of the present disclosure may improve the diversity, accuracy, and breadth of synthetic data generated by generative machine learning models. Ultimately, this reduces and in some cases eliminates fine-tuning and/or additional training operations for a downstream model and, by doing so, improve training speeds and model performance.

Historically, synthetic text samples have been generated manually, using rule-based methodologies, simple statistical models, and/or constrained generative techniques. These approaches, however, struggle to capture the complexity and nuances of natural language, resulting in generated samples that lacked diversity, coherence, or semantic relevance to the original data. Additionally, traditional methods faced challenges in balancing the trade-off between maintaining statistical similarity to the source data and introducing sufficient variability to create meaningful synthetic samples.

Embodiments of the present disclosure address these technical challenges by augmenting a generative model with a new cost function via expectation maximization and gradient descent optimization. The cost function, for example, may comprise two balancing components: (1) a similarity measure based on an embedding distance between generated and true data distributions, and (2) a variation measure that maximizes the difference between expected values of the generative learning output for generated data. By optimizing this cost function, the generative machine learning model may be guided in a reinforcement learning-like fashion to produce synthetic samples that accurately represent the complexity and nuances of natural language from input text samples while maintaining the necessary diversity for robust model training. In this way, the synthetic data generation and generative machine learning techniques (e.g., hardware, software, machine learning models, and/or a combination thereof) of the present disclosure may improve the quality (e.g., in terms of diversity, coherence, or semantic relevance) of synthetic data generated by a generative machine learning model by balancing similarity and diversity with respect to input data provided to the generative machine learning model. As described herein, the techniques of the present disclosure may iteratively refine the quality of synthetic data generated by a generative machine learning model, addressing the limitations of traditional text generation methods and enabling usage of the synthetic data to improve training of downstream machine learning models. Other technical improvements and advantages may be realized by one of ordinary skill in the art.

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or, in limited cases, identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

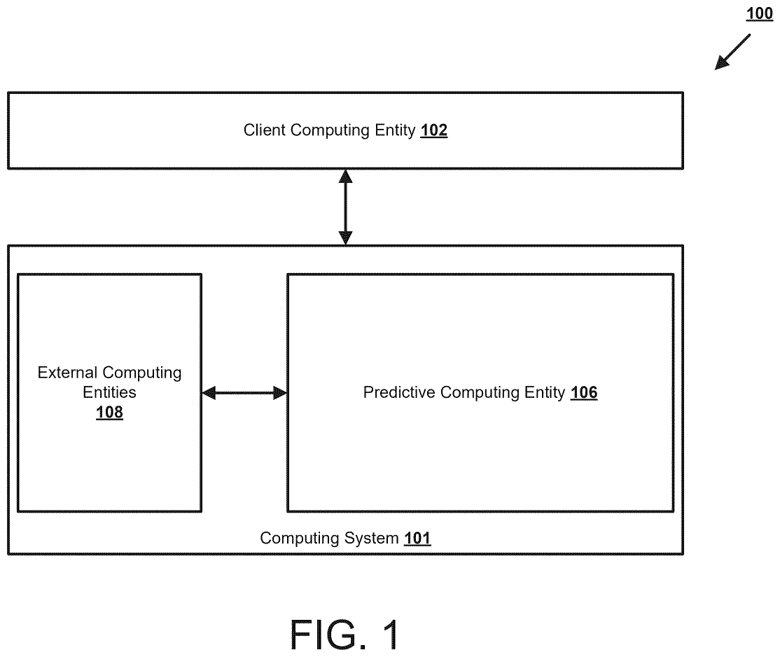

FIG. 1 depicts a block diagram of an example architecture 100 in accordance with some embodiments of the present disclosure. The architecture 100 comprises a computing system 101 configured to receive a request, such as a synthetic sample prompt, and/or the like, from client computing entities 102, process the synthetic sample prompt, and provide the responses (e.g., synthetic samples) to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learning models may be trained to generate candidate outputs (e.g., synthetic samples), candidate output scores, and/or other machine learning outputs. The models may be adapted to a differential request handling engine and/or complementary scoring mechanism that may collectively process a request using a generative machine learning model.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive a request, such as a synthetic sample prompt, and/or the like, from client computing entities 102, process the synthetic sample prompt, and provide the responses (e.g., synthetic samples) to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, up to each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., synthetic data generation techniques, training data generation techniques, generative machine learning techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as a corpus of text data, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and/or aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

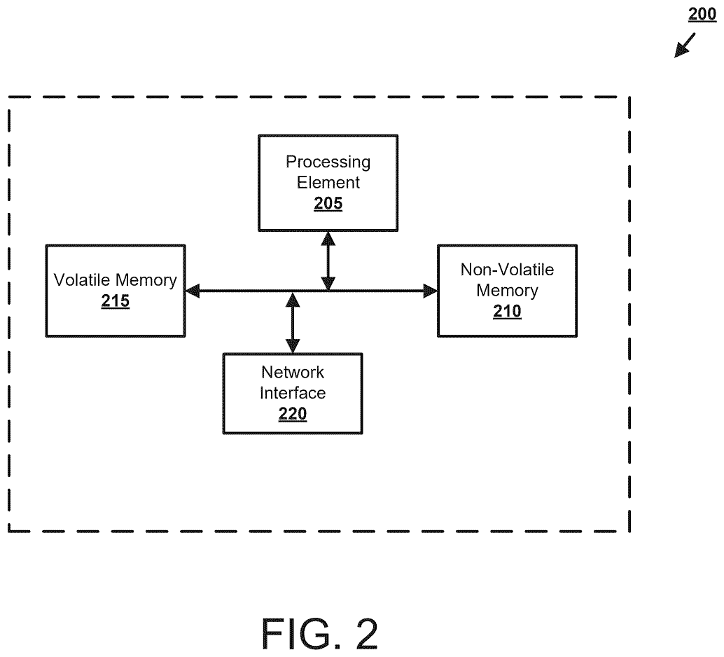

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium that may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

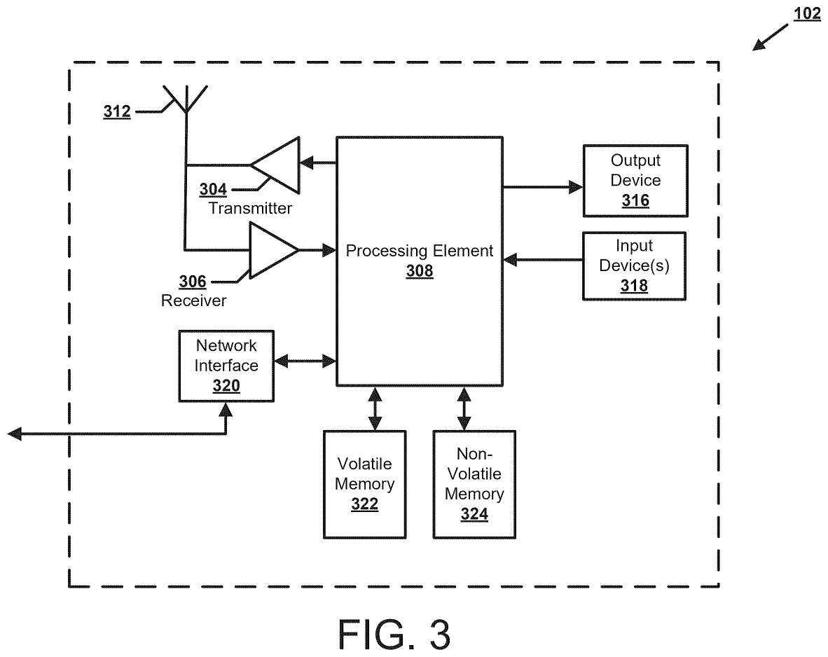

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine learning model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to data simulation by transforming input real-world data (e.g., a corpus sample) to synthetic data (e.g., a synthetic sample) that mimics the real-world data. In particular, systems and methods are disclosed herein that implement synthetic data generation and generative machine learning techniques to improve data diversity for training downstream machine learning models. By doing so, the synthetic data generation and generative machine learning techniques provide improved accuracy of classification and/or prediction output generated by the downstream machine learning models. This, in turn, may improve the functionality of a computer with respect to various computing tasks (e.g., that the computer is configured to perform using the downstream machine learning models), comprising document classification, content filtering, data security, machine learning model training, network traffic analysis, and the like.

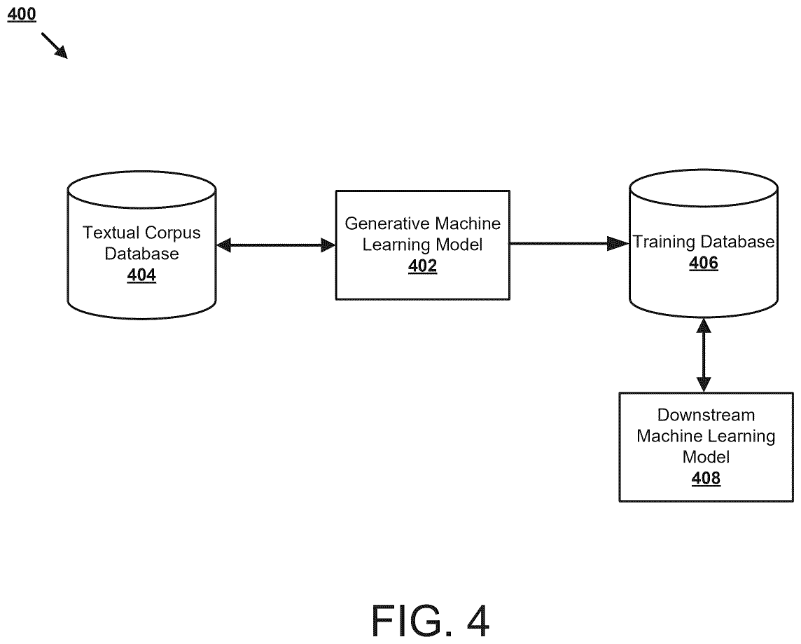

FIG. 4 depicts a dataflow diagram 400 of example synthetic training data generation approach in accordance with some embodiments of the present disclosure. The dataflow diagram 400, for example, illustrates a machine learning model training system that leverages a generative machine learning model 402 and a textual corpus database 404 to generate a training database 406 for training a downstream machine learning model 408. As described herein, the machine learning model training system may improve the performance of traditional machine learning models by augmenting textual data within the textual corpus database 404 with synthetic samples that improve the diversity of training samples while maintaining a measure of semantic similarity. To do so, the machine learning model training system may iteratively apply the generative machine learning model 402 and a genetic scoring methodology to reinforce textual variation while penalizing semantic differences between synthetic training data and the textual corpus database 404. This enables the generation of a training database 406 of diverse samples that accurately represent an underlying data distribution, which may improve the performance of downstream machine learning models 408 with respect to various language processing tasks. In this way, the synthetic training data generation approach of the present disclosure may reduce both the memory and processing resource requirements (e.g., by expanding training data from limited distributions) of traditional machine learning training techniques while improving model performance.

The machine learning model training system is configured to obtain textual data for storage within a textual corpus database 404. Corpus samples are retrieved from the textual corpus database 404 by the machine learning model training system and/or provided to a generative machine learning model 402. The generative machine learning model 402 is used to generate synthetic samples. The synthetic samples may be evaluated with respect to one or more parameters and/or stored to a training database 406 based on their evaluations. Evaluating the synthetic samples may comprise generating a model performance score. The model performance score may be provided to the generative machine learning model 402 as feedback for improving the ability of generative machine learning model 402 to generate synthetic samples in accordance with the one or more parameters. The training database 406 may comprise a storage of corpus samples (e.g., selected from the textual corpus database 404) and/or synthetic samples (e.g., generated by the generative machine learning model 402). The corpus samples and/or synthetic samples may be retrieved to generate training data for training a downstream machine learning model 408. In this way, the machine learning model training system may provide improved synthetic data generation techniques that combine the generative machine learning model 402 with a genetic algorithm-based approach.

In some embodiments, a sample text embedding of a corpus sample is generated using an encoder of the generative machine learning model 402.

In some embodiments, a corpus sample comprises a textual data object that is sampled from a corpus of data. A corpus sample, for example, may comprise a portion of text extracted from a larger collection of textual data, such as documents, articles, books, messages, and/or the like that is recorded and/or stored in an electronic format. The corpus from which corpus samples are drawn may be stored in one or more databases, such as relational databases, document-oriented databases, distributed storage systems, and/or the like.

In some embodiments, a corpus sample is determined using one or more sampling techniques, such as random sampling, cluster sampling, and/or the like. In some examples, a natural language processing (NLP) system may employ algorithms to identify and/or extract portions of text based on predefined criteria, such as keyword matching, semantic similarity, and/or statistical measures reflective of a text importance. The sampling process may leverage tokenization, where a portion of text is broken down into individual words and/or phrases, and/or additionally or alternatively utilize techniques, such as term frequency-inverse document frequency (TF-IDF), to assess the relevance of specific terms within the corpus. In some examples, a corpus sample may be determined based on a TF-IDF score, and/or the like.

As described herein, a corpus sample may be leveraged by a machine learning and/or NLP model, such as generative machine learning model 402 to generate training data for the downstream machine learning model 408. For example, using one or more techniques of the present disclosure, the generative machine learning model 402 (e.g., comprising one or more language models, sentiment analysis systems, and/or generative text models) may process a corpus sample to generate a training dataset that may be used to train a classification machine learning model. In some examples, one or more corpus samples may be preprocessed to remove noise, normalize text, and/or extract features before being input into the downstream machine learning model 408. For instance, a corpus sample may undergo stemming and/or lemmatization to reduce words to their base forms, thereby enhancing the efficiency of subsequent analysis.

In some embodiments, an embedding comprises a latent representation of data comprising one or more features. An embedding may be expressed as a vector comprising one or more binary, numerical, alphabetic, alpha-numeric, symbolic, and/or the like values, representative of one or more features associated with content of data. For example, in natural language processing applications, word embeddings may capture semantic relationships between words by representing them as dense vectors in a high-dimensional space.

Generating embeddings may involve machine learning algorithms and/or neural network architectures. For example, embeddings may be generated using techniques such as Word2Vec, GloVe, and/or more advanced transformer-based models like BERT (Bidirectional Encoder Representations from Transformers). Such models may be trained on large corpora of text data to learn contextual relationships and/or semantic meanings.

In some embodiments, embeddings may be used for dimensionality reduction, compressing high-dimensional data into more manageable representations while preserving important features. Additionally, embeddings may facilitate similarity computations, allowing for efficient nearest neighbor searches and/or clustering of related data points in the embedding space. Furthermore, hierarchical embeddings may be employed to capture relationships at different levels of granularity, such as character-level, word-level, sentence-level embeddings, and/or the like, in language models.

In some embodiments, an encoder comprises a structure of the generative machine learning model 402 that is configured to receive and/or transform input data, such as a corpus sample, into embeddings. An encoder may comprise one or more encoding layers that progressively extract and/or compress features from the input data. For example, in a natural language processing task, an encoder may receive a sequence of words or tokens as input and produce a dense vector representation that captures the semantic meaning of the input text.

Implementation of an encoder may involve various neural network architectures, such as recurrent neural networks (RNNs), convolutional neural networks (CNNs), or transformer-based machine learning models. In some embodiments, an encoder may utilize attention mechanisms to focus on relevant parts of the input data during the encoding process. An encoder's parameters may be learned through backpropagation during the training of the generative machine learning model 402.

In some embodiments, encoders may serve as feature extractors, transforming raw input data into a format that is more suitable for downstream tasks. For example, the output of an encoder, referred to as a latent representation or embedding, may be used as input for other components within the generative machine learning model 402, such as decoders and/or classifiers. Additionally, encoders may be pre-trained on large datasets and/or fine-tuned for specific tasks, enabling transfer learning and/or improving performance on tasks with limited labeled data.

In some embodiments, the generative machine learning model 402 comprises a pre-trained large language model that is configured to generate synthetic samples based on input data (e.g., corpus samples). The generative machine learning model 402 may be designed to learn and/or capture the underlying distribution of training data, enabling it to generate new, similar data samples.

The generative machine learning model 402 may comprise various neural network architectures, such as transformers, RNNs, or CNNs. In some embodiments, the generative machine learning model 402 may utilize attention mechanisms, self-supervised learning techniques, or autoregressive approaches to capture complex patterns in the input data.

In some embodiments, the generative machine learning model 402 may be employed to generate synthetic text samples for generating training data used to train the downstream machine learning model 408 for classification tasks, such as sentiment analysis. For example, the generative machine learning model 402 may take a corpus sample as input and/or generate a sample text embedding using an encoder component of the generative machine learning model 402. Subsequently, a decoder component of the generative machine learning model 402 may generate a synthetic sample based on the sample text embedding and/or a synthetic sample prompt.

In some embodiments, the generative machine learning model 402 may be guided in a reinforcement learning-like process to improve the quality of synthetic samples generated over multiple iterations. This fine-tuning process may incorporate feedback using a genetic algorithm-approach that comprises an application of a cost function. The cost function may be used to generate a similarity measure and/or a variation measure based on a comparison of the sample text embedding with a synthetic text embedding of the synthetic sample. Alternative embodiments of the generative machine learning model 402 may comprise conditional generation capabilities, where additional control signals or attributes may guide the generation process.

In some embodiments, reinforcement learning comprises a machine learning technique that is used to train an artificial intelligence unit, such as an intelligent agent, to make decisions to achieve best-effort results based on a reward-and-penalty paradigm. Reinforcement learning may involve an agent interacting with an environment, learning to take actions that maximize cumulative rewards over time. For text generation tasks, reinforcement learning may be used to fine-tune language models by providing rewards based on desired text properties such as coherence, relevance, and/or style.

Reinforcement learning techniques may utilize rewards and/or penalties based on model performance scores to guide the learning process. In some embodiments, a reward may be generated by determining a model performance score associated with an output generated by a machine learning model and/or determining that the model performance score satisfies a threshold. In addition, or alternatively, a penalty may be generated when the model performance score does not satisfy the threshold. These rewards and/or penalties may be used to update the model's policy and/or value function, encouraging behaviors that lead to high performance scores and discouraging those that result in low scores.

In some embodiments, a synthetic sample is generated, using a decoder of the generative machine learning model 402, based on the sample text embedding of the corpus sample.

In some embodiments, a synthetic sample comprises output data that is generated by the generative machine learning model 402 by reconstructing, translating, and/or transforming an embedding of input data (e.g., a corpus sample) provided to the generative machine learning model 402. A synthetic sample may comprise artificially created data that mimics the characteristics and/or distribution of real data samples. For example, in a natural language processing context, a synthetic sample may be a generated text passage that exhibits similar linguistic properties to reference text.

A synthetic sample may be generated by using the generative machine learning model 402 (e.g., comprising neural network architectures, such as RNNs, CNNs, or transformers). For example, the generative machine learning model 402 may use techniques, such as self-attention, autoregressive generation, and/or latent space sampling to produce a synthetic sample. The synthetic sample generation process may be guided by a synthetic sample prompt, which may be incorporated into input provided to the generative machine learning model 402 and/or used to condition its internal states.

In some embodiments, synthetic samples may be used to provide training data for training the downstream machine learning model 408. For example, synthetic samples may be employed to balance datasets, addressing issues of data scarcity and/or class imbalance. The generation of synthetic samples may involve post-processing steps, such as filtering and/or quality assessment, to ensure that the generated synthetic samples meet specific criteria and/or standards.

In some embodiments, synthetic sample generation may comprise hybrid methods that combine rule-based systems with machine learning models. In some embodiments, synthetic samples may be generated through iterative refinement processes, where initial samples are progressively improved based on feedback and/or evaluation metrics. Additionally, synthetic samples may be designed to preserve certain properties, such as similarity and/or variation with respect to reference samples from which the synthetic samples are generated based on.

In some embodiments, a synthetic sample prompt comprises instructions that may be provided to the generative machine learning model 402 for generating a synthetic sample based on a corpus sample. A synthetic sample prompt may comprise natural language text, structured data, or a combination thereof, designed to guide the generation process of the generative machine learning model 402. For example, in a synthetic sample generation task, a synthetic sample prompt may comprise a partial sentence or a set of keywords that the generative machine learning model 402 should incorporate into its output.

In some embodiments, a synthetic sample prompt may be encoded into a format compatible with an input layer of the generative machine learning model 402. In some embodiments, the encoding of a synthetic sample prompt may involve tokenization, where the synthetic sample prompt is deconstructed into individual tokens that may be processed by the generative machine learning model 402. The encoded synthetic sample prompt may be represented as a vector or tensor, which may be concatenated with and/or used to condition internal representations of the generative machine learning model 402 during the synthetic sample generation process.

In some embodiments, synthetic sample prompts may be dynamically generated based on user input and/or system requirements, allowing for interactive and/or customizable content generation. The synthetic sample prompts may also be designed to incorporate specific constraints and/or style guidelines, enabling fine-grained control over the generated output.

The functionality of synthetic sample prompts may extend beyond instruction provision. In some embodiments, prompts may be structured to comprise multiple components, such as content descriptors, style indicators, and/or control parameters. This multi-faceted approach may allow for more nuanced and/or context-aware synthetic sample generation. Additionally, synthetic sample prompts may be used in conjunction with other techniques, such as few-shot learning or in-context learning, to guide the generative machine learning model 402 towards generating synthetic samples that align with specific examples and/or patterns.

In some embodiments, a decoder comprises a structure of the generative machine learning model 402 that is configured to transform, translate, and/or reconstruct embeddings generated by a respectively corresponding encoder of the generative machine learning model 402 into output data, such as a synthetic sample. A decoder may comprise one or more decoding layers that progressively expand and reconstruct features from the latent representation provided by the encoder.

The implementation of a decoder may mirror that of the encoder, that is, utilizing similar neural network architectures but in reverse order. For example, a decoder may receive the encoder's output (e.g., sample text embedding) as input and generate a sequence of words (e.g., comprising a synthetic sample) based on one or more criteria (e.g., a cost function). In some embodiments, decoders may incorporate additional mechanisms to improve output quality, such as beam search for synthetic sample generation. The output of a decoder may be post-processed to refine generated synthetic samples, such as applying temperature scaling to control the randomness of synthetic sample generation. The functionality of decoders may extend to conditional generation tasks, where additional input and/or control signals are provided to guide the synthetic sample generation process.

In some embodiments, a synthetic text embedding of the synthetic sample is generated using the encoder of the generative machine learning model 402. In some embodiments, a similarity measure for the synthetic sample is generated, using a cost function, based on a first comparison between the synthetic text embedding and the sample text embedding. For example, the cost function comprises a genetic fitness function that defines an expectation minimization function, an expectation maximization function, and an aggregate scoring function. In some embodiments, the first comparison comprises applying the expectation minimization function to the synthetic text embedding and the sample text embedding. In some embodiments, the second comparison comprises applying the expectation maximization function to the synthetic text embedding and the sample text embedding. In some embodiments, the expectation minimization function minimizes a distance between the synthetic text embedding and the sample text embedding. In some embodiments, the expectation maximization function maximizes a gradient between the synthetic text embedding and the sample text embedding. In some embodiments, the gradient between the synthetic text embedding and the sample text embedding is determined at a stochastically sampled point of the synthetic text embedding and the sample text embedding. In some embodiments, the sample text embedding comprises a first distribution of word-level embeddings and the synthetic text embedding comprises a second distribution of word-level embeddings.

In some embodiments, a similarity measure comprises a function for measuring statistical and/or semantic similarity between two data objects. For example, a similarity measure may be used to determine a similarity between input data received by the generative machine learning model 402 and output data generated by the generative machine learning model 402. In some embodiments, a similarity measure may be implemented as a mathematical function that quantifies the degree of resemblance or correspondence between two sets of data.

In some embodiments, a similarity measure may be based on statistical methods such as cosine similarity, Jaccard index, or Pearson correlation coefficient. Such statistical methods may be implemented using linear algebra libraries and optimized matrix operations to handle large-scale data efficiently. In other cases, more sophisticated techniques like kernel methods and/or neural network-based similarity measures may be employed.

In some embodiments, a similarity measure may be used to evaluate the performance of the generative machine learning model 402 by comparing the distribution of generated samples with the distribution of real data. This comparison may involve techniques from information theory, such as Kullback-Leibler divergence or mutual information, which may be implemented using numerical integration methods or Monte Carlo sampling techniques.

In some embodiments, a cost function comprises a relationship between input data (e.g., corpus sample) received by the generative machine learning model 402 and output data (synthetic sample) generated by the generative machine learning model 402. A cost function may be used to generate a model performance score for evaluating the performance of the generative machine learning model 402 by comparing input data and output data with respect to a plurality of measures. For example, a cost function may comprise a relationship between a similarity measure and a variation measure that are associated with input data received by the generative machine learning model 402 and output data generated by the generative machine learning model 402.

A cost function may involve complex mathematical formulations and/or optimization techniques. For example, a cost function may be based on the principle of expectation maximization, which may comprise an iterative method for finding maximum likelihood or maximum a posteriori estimates of parameters. The cost function may also incorporate gradient descent optimization, which may comprise a first-order iterative optimization algorithm for finding a local minimum of a differentiable function.

In some embodiments, the cost function may comprise a similarity measure based on the Wasserstein distance between the generated data distribution and the true data distribution. The Wasserstein distance, also known as the earth mover's distance, may be computed using optimal transport theory and provides a measure of the distance between two probability distributions. Additionally, a similarity measure may be implemented using computational techniques such as the Sinkhorn algorithm or linear programming solvers.

The cost function may also comprise a variation measure based on maximizing the difference between expected values of generative learning output (e.g., synthetic samples) and input data (e.g., corpus samples). The variation measure may be implemented using gradient-based optimization techniques, such as stochastic gradient descent, or adaptive learning rate methods, such as Adam optimizer, RMSprop, and/or the like. The computation of expected values may involve Monte Carlo sampling or other numerical integration techniques.

In some embodiments, the cost function may be employed during the training phase of the generative machine learning model 402 to guide an optimization process and improve the quality of generated synthetic samples. The cost function may be evaluated at up to each iteration of the training process, with the model parameters updated based on the computed gradients of the cost function.

In some embodiments, cost functions may be designed to incorporate multiple objectives, allowing for trade-offs between different aspects of model performance. For example, in a synthetic sample generation task, the cost function may balance similarity to the input data (e.g., corpus sample) with diversity of generated samples. Additionally, cost functions may be used to enforce constraints and/or regularization on the generative machine learning model 402, such as sparsity or smoothness of learned representations.

Alternative embodiments of cost functions may comprise adaptive and/or dynamic formulations that evolve during the training process. In some embodiments, the cost function may be learned or meta-learned, allowing the optimization objective to be automatically tuned based on the specific characteristics of the data or task at hand. Furthermore, cost functions may be designed to incorporate domain-specific knowledge or constraints, enabling the integration of expert insights into the machine learning process and improving the interpretability and/or reliability of the generated outputs (e.g., synthetic samples).

In some embodiments, a variation measure for the synthetic sample is generated, using the cost function, based on a second comparison between the synthetic text embedding and the sample text embedding.

In some embodiments, a variation measure comprises a function for measuring variability between two data objects. For example, a variation measure may be used to determine a difference between input data received by the generative machine learning model 402 and output data generated by the generative machine learning model 402. In some embodiments, a variation measure may be implemented as a mathematical function that quantifies the degree of dissimilarity and/or divergence between two sets of data.

In some embodiments, a variation measure may be based on distance metrics such as Euclidean distance, Manhattan distance, or Mahalanobis distance. Such distance metrics may be implemented using efficient vector operations and may be optimized for parallel computation on GPUs to handle high-dimensional data. In other cases, more complex variation measures may be employed, such as earth mover's distance or Wasserstein distance, which may require solving optimization problems and/or using approximation algorithms for efficient computation.

In some embodiments, a variation measure may be used to assess the diversity of synthetic samples generated by the generative machine learning model 402, ensuring that the generative machine learning model 402 produces a wide range of outputs rather than collapsing to a single mode. This assessment may involve techniques from information theory, such as entropy or mutual information, which may be implemented using numerical methods and/or sampling techniques.

In some embodiments, a model performance score is provided for the generative machine learning model 402 based on a comparison between the similarity measure and the variation measure.

In some embodiments, a model performance score comprises an output of a cost function that is representative of a performance of the generative machine learning model 402 with respect to performing a task based on one or more parameters. A model performance score may provide a quantitative measure of how well the generative machine learning model 402 performs a given task. A model performance score may comprise multi-objective evaluation frameworks, where multiple performance metrics are considered simultaneously to provide a more comprehensive assessment of machine learning model quality. In some embodiments, a model performance score for the generative machine learning model 402 is generated based on a comparison between a similarity measure and a variation measure for a synthetic sample. In some embodiments, a model performance score may be used to implement early stopping criteria during model training, preventing overfitting by halting the training process when the performance on a validation set begins to degrade.

In some embodiments, the downstream machine learning model 408 comprises a classifier machine learning model.

In some embodiments, a classifier machine learning model comprises a machine learning model that is trained and/or configured to generate a classification output based on a data input. A classifier machine learning model may be designed to categorize input data into predefined classes or categories based on learned patterns and features. For example, in a sentiment analysis task, a classifier machine learning model may take a text input and classify it as positive, negative, or neutral sentiment.

A classifier machine learning model may comprise various algorithms and/or architectures, such as support vector machines (SVMs), decision trees, random forests, or neural networks, and/or the like. In some embodiments, a classifier machine learning classifier may be implemented using deep learning techniques, such as convolutional neural networks (CNNs) for image classification or recurrent neural networks (RNNs) for sequence classification tasks.

The training process of a classifier machine learning model may involve supervised learning techniques, where the model learns from labeled training data. In some embodiments, the training data may be represented as feature vectors, with up to each vector corresponding to an input sample and its associated class label. The model may use optimization algorithms such as stochastic gradient descent to adjust its internal parameters and minimize a loss function, such as cross-entropy loss for multi-class classification problems. The training process may also involve techniques like regularization to prevent overfitting and improve generalization to unseen data.

In natural language processing, classifiers may be employed for tasks such as spam detection, topic classification, or language identification. In computer vision, classifiers may be used for object recognition, facial expression analysis, or medical image diagnosis. In bioinformatics, classifiers may be applied to protein function prediction or gene expression analysis. In some embodiments, classifiers may be designed to handle multi-label classification, where an input sample may belong to multiple categories simultaneously. Additionally, classifiers may be adapted for hierarchical classification tasks, where classes are organized in a tree-like structure, allowing for more fine-grained categorization of inputs.

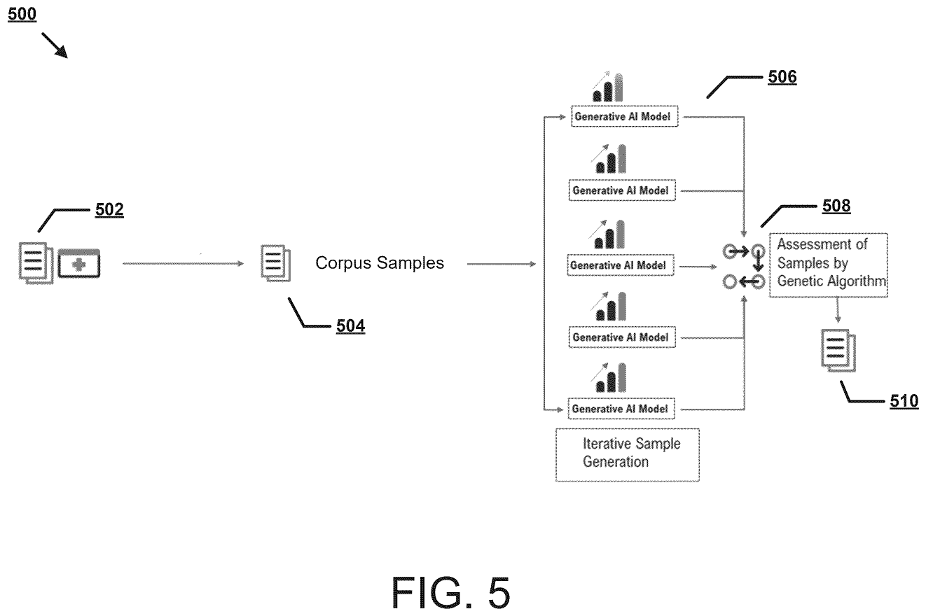

FIG. 5 is an operational example 500 of a genetic algorithm-based generative learning framework in accordance with some embodiments of the present disclosure. As shown in the operational example 500, an iterative sample generation process 508 is provided by generating, using a generative machine learning model (e.g., generative machine learning model 402), a set of synthetic samples 506 based on one or more corpus samples 504 that are sampled from the corpus training data 502. During the iterative sample generation process 508, the set of synthetic samples 506 may be assessed based on a genetic algorithm. Assessing the set of synthetic samples 506 may comprise determining a set of model performance scores that respectively corresponds to the set of synthetic samples 506. A subset of synthetic samples 510 is determined from the set of synthetic samples 506 based on a subset of highest scoring model performance scores from the set of model performance scores. A synthetic sample is added to a training dataset in response to a determination that the synthetic sample is one of the subset of synthetic samples 510. In this way, the genetic algorithm-based generative learning framework may provide improved generative machine learning techniques that improves the quality of synthetic data generated by generative machine learning models, thereby reducing or eliminating the need for fine-tuning or additional training of the generative machine learning model in situations where the availability of training data may be limited.

In some embodiments, the synthetic sample is added to a training dataset based on the similarity measure.

In some embodiments, a training dataset comprises data that is used to train a machine learning model to perform a desired prediction task. A training dataset may comprise a collection of data samples that are representative of a problem domain and are used to teach a machine learning model to recognize patterns, make decisions, and/or generate outputs. For example, in a natural language processing task, a training dataset may comprise a large corpus of text documents along with their corresponding labels and/or annotations. In some embodiments, training datasets may be augmented with synthetic data generated by generative machine learning models to increase the diversity and size of the dataset.

Training datasets may be preprocessed and transformed to make them suitable for machine learning algorithms. Preprocessing may comprise techniques, such as normalization, feature scaling, and/or encoding categorical variables.

In some embodiments, the corpus sample is associated with a training label and adding the synthetic sample to the training dataset comprises (i) assigning the training label to the synthetic sample and (ii) storing the synthetic sample and the training label as a supervised training pair within the training dataset.

In some embodiments, a training label comprises a data construct that is representative of an actual classification of data in a training dataset. A training label may establish an association between one or more features of a training data object and a classification. For example, in a text classification task, a training label may indicate whether a text contains a specific content and/or belongs to a particular category.

In some embodiments, for binary classification problems, training labels may be represented as binary values (e.g., ‘0’ or ‘1’) stored as Boolean data types. For multi-class classification tasks, labels may be encoded using one-hot encoding, where up to each class is represented by a binary vector.

In some embodiments, training labels may be used in conjunction with loss functions to guide the learning process of machine learning models. In some embodiments, the choice of loss function may depend on the type of training labels and the specific learning task. For example, binary cross-entropy loss may be used for binary classification tasks, while categorical cross-entropy loss may be employed for multi-class classification problems. The computation of loss functions may be optimized using automatic differentiation techniques provided by deep learning frameworks. Additionally, training labels may be designed to capture hierarchical relationships between classes, enabling the development of models that may perform fine-grained classification tasks.

In some embodiments, a supervised training pair comprises an example pairing of a training label and a training data object comprising one or more features. A supervised training pair may provide a concrete instance of input data along with its corresponding desired output, which is used to teach a machine learning model the relationship between inputs and outputs. For example, in a sentiment analysis task, a supervised training pair may comprise a body of text as an input data object and a sentiment label (e.g., positive, negative, or neutral) as the training label.

In some embodiments, supervised training pairs may be stored as tuples or dictionaries in programming languages, allowing for easy access to both the input data and the associated label. For large-scale machine learning tasks, supervised training pairs may be organized into specialized data formats such as TFRecord files in TensorFlow or dataset objects in PyTorch, which may be optimized for efficient loading and/or processing during model training.

Supervised training pairs may be used in various machine learning algorithms, comprising neural networks, support vector machines, and decision trees. In some embodiments, the process of using supervised training pairs may involve iterating over batches of supervised training pairs, computing a machine learning model's predictions, and adjusting the machine learning model's parameters based on a difference between the predicted and actual labels. Such a process may be implemented using optimization algorithms, such as stochastic gradient descent or Adam optimizer.

In some embodiments, the training label is one of a negative training label, a positive training label, or a neutral training label. In some embodiments, the corpus sample is one of a set of corpus samples of a corpus training data.

In some embodiments, a positive training label comprises an identification of training data that comprises a positive classification and/or feature. A positive training label, for example, may be used in machine learning systems to indicate desirable outcomes, correct classifications, the presence of specific attributes, and/or the like, in training datasets. For example, a positive training label may be assigned to a corpus sample to express desirable content, opinion, emotion, and/or the like.

In some examples, a positive training label may comprise a binary encoding, where a value of ‘1’ may represent the positive class. In addition, or alternatively, for example in a multi-class classification problems, a one-hot encoding technique may be employed in which the positive training label is represented by a specific position in a vector.

A positive training label may be used to guide the learning process of machine learning algorithms, allowing machine learning models to adjust their parameters to correctly identify and classify positive instances. During training, a machine learning model may compare its predictions against positive training labels to compute loss functions and update weights accordingly. Such a process may involve techniques such as gradient descent optimization and/or backpropagation in neural networks.

In some embodiments, a negative training label comprises an identification of training data that comprises a negative classification or feature. A negative training label, for example, may be used to indicate undesirable outcomes, incorrect classifications, the absence of specific attributes, and/or the like, in training datasets. For example, a negative training label may be assigned to a corpus sample to express an undesirable content, opinion, emotion, and/or the like.

In some examples, a positive training label may comprise a binary encoding, where a value of ‘0’ may represent the negative class. In addition, or alternatively, for example in a multi-class classification problems, negative training labels may be represented by the absence of activation in specific positions of one-hot encoded vectors.

A negative training label may be used to create a balanced training dataset and prevent bias in machine learning models. For example, a negative training label may be used in conjunction with a positive training label to calculate performance metrics such as precision, recall, F1 scores, and/or the like. In some embodiments, such as anomaly detection and/or rare event prediction, negative training labels may constitute the majority of the training data, requiring special handling techniques like oversampling or undersampling to address class imbalance issues. Alternative uses of negative training labels comprise their application in contrastive learning approaches, where models learn to distinguish between positive and negative examples.

In some embodiments, a neutral training label comprises an identification of training data that comprises a neutral classification or feature. Neutral training labels may be used in machine learning tasks where the classification is not binary and comprises a middle ground and/or indeterminate state. For example, in sentiment analysis, a neutral training label may be assigned to text that expresses neither positive nor negative sentiment.

The implementation of neutral training labels may involve using a ternary encoding system, where 0 represents negative, 1 represents positive, and 0.5 or 2 represents neutral. In more sophisticated systems, neutral training labels may be represented as a separate dimension in multi-dimensional classification spaces.

Neutral training labels may serve to create nuanced machine learning models. For example, neutral training labels may help in training systems to recognize ambiguity or lack of strong sentiment, in applications, such as social media analysis, customer feedback processing, or natural language understanding. In some embodiments, neutral training labels may be used to create buffer zones in decision boundaries, potentially improving the robustness of classification models.

In some embodiments, the corpus sample is one of a set of corpus samples 504 of a corpus training data 502 and adding the synthetic sample to the training dataset comprises (i) generating a set of synthetic samples 506 using one or more corpus samples 504 stochastically sampled from the corpus training data 502, (ii) determining a set of model performance scores that respectively corresponds to the set of synthetic samples 506, (iii) determining a subset of synthetic samples 510 from the set of synthetic samples 506 based on a subset of highest scoring model performance scores from the set of model performance scores, and (iv) adding the synthetic sample to the training dataset in response to a determination that the synthetic sample is one of the subset of synthetic samples 510.

In some embodiments, the generative machine learning model is trained based on the model performance score. In some embodiments, a reward or a penalty is determined for the generative machine learning model based on the model performance score.

In some embodiments, a reward comprises positive feedback that may be provided to a machine learning model, such as a generative machine learning model, to indicate to the machine learning model a desired suitability, fitness, and/or correctness of an output generated by the machine learning model. A reward may serve as a signal to reinforce certain behaviors or outputs of the model, encouraging it to produce similar results in future iterations.

In some embodiments, generating a reward comprises determining a model performance score that is associated with an output generated by a machine learning model and determining that the model performance score satisfies a threshold. The reward may be represented as a numerical value, such as a floating-point number, which may be used to update the model's parameters and/or weights.

Rewards may be utilized in various machine learning paradigms, such as in reinforcement learning scenarios. In some embodiments, rewards may be integrated into the loss function of a neural network, influencing the optimization process during training. Alternative approaches to reward mechanisms may comprise multi-objective reward functions, where multiple criteria are considered simultaneously to provide a more nuanced evaluation of the model's performance.

In some embodiments, a penalty comprises negative feedback that may be provided to a machine learning model, such as a generative machine learning model, to indicate to the machine learning model an undesired suitability, fitness, and/or correctness of an output generated by the machine learning model. A penalty may serve as a signal to discourage certain behaviors or outputs of the model, steering it away from producing similar results in future iterations.

In some embodiments, generating a penalty may comprise determining a model performance score that is associated with an output generated by a machine learning model and determining that the model performance score does not satisfy a threshold. This process may be implemented using conditional logic and comparison operations in programming languages, with the penalty potentially represented as a negative numerical value or a separate flag indicating undesirable output.

Penalties may be employed in various machine learning algorithms, particularly in scenarios where avoiding certain outcomes is as important as achieving desired ones. In some embodiments, penalties may be incorporated into the regularization terms of a model's objective function, discouraging overfitting or promoting sparsity in the learned parameters.

In some embodiments, penalties may be designed with varying degrees of severity, allowing for a more nuanced approach to guiding the model's learning process. This graduated penalty system may be implemented using a continuous scale or discrete levels, depending on the specific requirements of the learning task. Additionally, penalties may be used in conjunction with rewards to create a balanced learning environment, where the model learns to navigate complex trade-offs between different objectives.

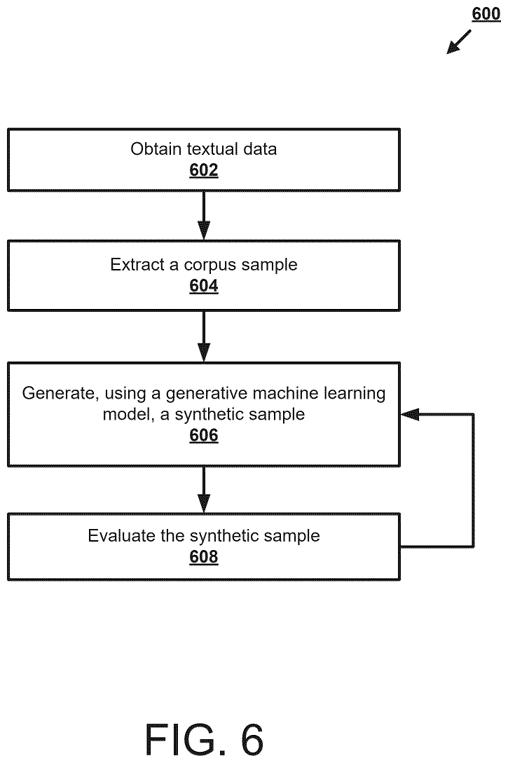

FIG. 6 depicts a flowchart diagram of an example genetic algorithm-based generative learning process 600 in accordance with some embodiments of the present disclosure. The flowchart diagram depicts an improved synthetic data generation technique that combines a generative machine learning model with a genetic algorithm-based approach that improves the generation of synthetic samples that accurately represent the complexity and nuances of natural language from input text samples while maintaining the necessary diversity for training a downstream classification machine learning model. The process 600 may be implemented by one or more computing devices, entities, and/or systems described herein. For example, via the various steps/operations of the process 600, the computing system 101 may guide a generative machine learning model in a reinforcement learning-like manner to improve the quality of synthetic samples generated by the generative machine learning model over multiple iterations. By doing so, the process 600 improves computer functionality by improving the functionality of a computer with respect to generating high-quality, diverse synthetic text samples for generating training data for natural language processing classification and/or prediction tasks.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 comprises, at operation 602, obtaining textual data. For example, the computing system 101 may obtain textual data.

In some embodiments, the process 600 comprises, at operation 604, extracting a corpus sample. For example, the computing system 101 may extract a corpus sample.

In some embodiments, the process 600 comprises, at operation 606, generates, using a generative machine learning model, a synthetic sample. For example, the computing system 101 may generate, using a generative machine learning model, a synthetic sample.

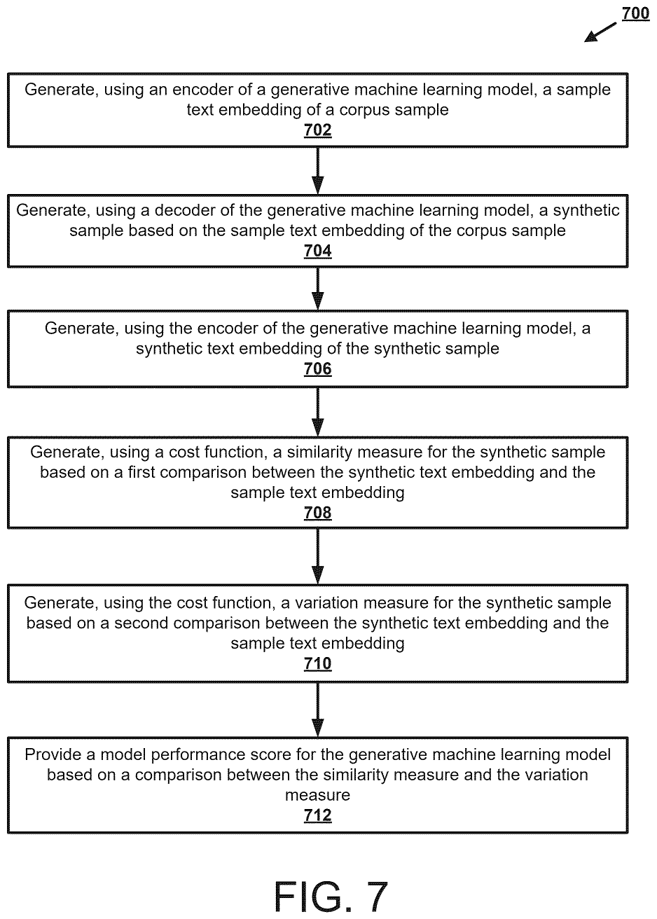

In some embodiments, the process 600 comprises, at operation 608, evaluate the synthetic sample. For example, the computing system 101 may evaluate the synthetic sample. Evaluation of a synthetic sample is described in further detail with respect to the description of FIG. 7.

FIG. 7 depicts a flowchart diagram of an example generative learning evaluation process 700 in accordance with some embodiments of the present disclosure. The flowchart diagram depicts an improved generative machine learning technique that improves the quality of synthetic data generated by generative machine learning models, thereby reducing or eliminating the need for fine-tuning or additional training of the generative machine learning model in situations where the availability of training data may be limited. The process 700 may be implemented by one or more computing devices, entities, and/or systems described herein. For example, via the various steps/operations of the process 700, the computing system 101 may generate a model performance score for evaluating a synthetic sample generated by the generative machine learning model, and in turn, a performance of a generative machine learning model based on a cost function. By doing so, the process 700 improves computer functionality by improving generative machine learning models such that fine-tuning or additional training of the generative machine learning model may be reduced or eliminated in situations where the availability of training data may be limited.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 comprises, at operation 702, generating, using an encoder of a generative machine learning model, a sample text embedding of a corpus sample. For example, the computing system 101 may generate, using an encoder of a generative machine learning model, a sample text embedding of a corpus sample.

In some embodiments, the process 700 comprises, at operation 704, generating, using a decoder of the generative machine learning model, a synthetic sample based on the sample text embedding of the corpus sample. For example, the computing system 101 may generate, using a decoder of the generative machine learning model, a synthetic sample based on the sample text embedding of the corpus sample.

In some embodiments, the process 700 comprises, at operation 706, generating, using the encoder, a synthetic text embedding of the synthetic sample. For example, the computing system 101 may generate, using the encoder, a synthetic text embedding of the synthetic sample.

In some embodiments, the process 700 comprises, at operation 708, generating, using a cost function, a similarity measure for the synthetic sample based on a first comparison between the synthetic text embedding and the sample text embedding. For example, the computing system 101 may generate, using a cost function, a similarity measure for the synthetic sample based on a first comparison between the synthetic text embedding and the sample text embedding.

In some embodiments, the process 700 comprises, at operation 710, generating, using the cost function, a variation measure for the synthetic sample based on a second comparison between the synthetic text embedding and the sample text embedding. For example, the computing system 101 may generate, using the cost function, a variation measure for the synthetic sample based on a second comparison between the synthetic text embedding and the sample text embedding.

In some embodiments, the process 700 comprises, at operation 712, providing a model performance score for the generative machine learning model based on a comparison between the similarity measure and the variation measure. For example, the computing system 101 may provide a model performance score for the generative machine learning model based on a comparison between the similarity measure and the variation measure.

In some embodiments, the generative machine learning model is trained based on the model performance score. In some embodiments, a reward or a penalty is determined for the generative machine learning model based on the model performance score.

In some embodiments, the cost function comprises a genetic fitness function that defines an expectation minimization function, an expectation maximization function, and an aggregate scoring function. In some embodiments, the first comparison comprises applying the expectation minimization function to the synthetic text embedding and the sample text embedding. In some embodiments, the second comparison comprises applying the expectation maximization function to the synthetic text embedding and the sample text embedding.

In some embodiments, the expectation minimization function minimizes a distance between the synthetic text embedding and the sample text embedding. In some embodiments, the expectation maximization function maximizes a gradient between the synthetic text embedding and the sample text embedding. In some embodiments, the gradient between the synthetic text embedding and the sample text embedding is determined at a stochastically sampled point of the synthetic text embedding and the sample text embedding. In some embodiments, the sample text embedding comprises a first distribution of word-level embeddings and the synthetic text embedding comprises a second distribution of word-level embeddings.

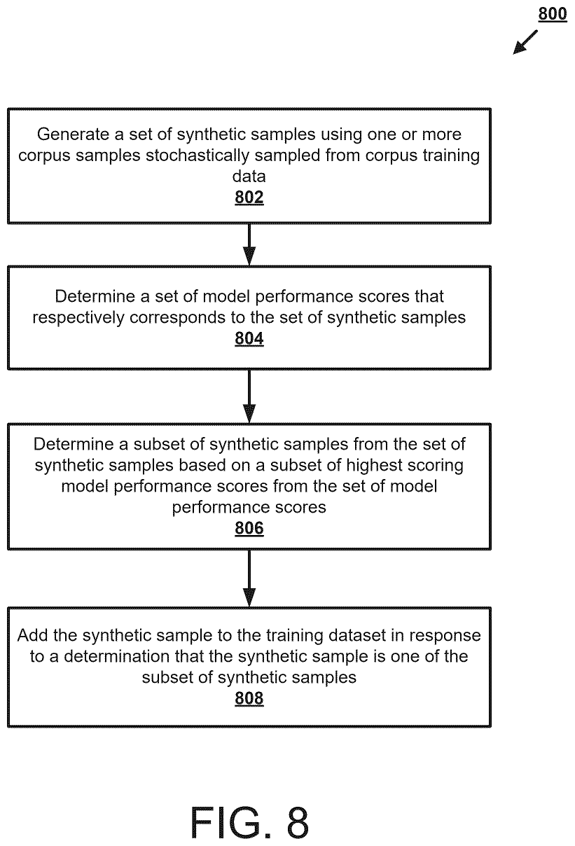

FIG. 8 depicts a flowchart diagram of an example training data generation process in accordance with some embodiments of the present disclosure. The flowchart diagram depicts an improved machine learning model training technique that improves a pool of data used to generate training data for training a machine learning model, thereby improving the model's performance (e.g., accuracy). The process 800 may be implemented by one or more computing devices, entities, and/or systems described herein. For example, via the various steps/operations of the process 800, the computing system 101 may determine a subset of synthetic data generated by a generative machine learning model that is added to a training dataset based on model performance score. By doing so, the process 800 improves computer functionality by improving training data used to train a machine learning model and thereby improving the performance (e.g., accuracy) of the machine learning model.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 comprises, at operation 802, generating a set of synthetic samples using one or more corpus samples stochastically sampled from the corpus training data. For example, the computing system 101 may generate a set of synthetic samples using one or more corpus samples stochastically sampled from the corpus training data.

In some embodiments, the process 800 comprises, at operation 804, determining a set of model performance scores that respectively corresponds to the set of synthetic samples. For example, the computing system 101 may determine a set of model performance scores that respectively corresponds to the set of synthetic samples.

In some embodiments, the process 800 comprises, at operation 806, determining a subset of synthetic samples from the set of synthetic samples based on a subset of highest scoring model performance scores from the set of model performance scores. For example, the computing system 101 may determine a subset of synthetic samples from the set of synthetic samples based on a subset of highest scoring model performance scores from the set of model performance scores.

In some embodiments, the process 800 comprises, at operation 808, adding the synthetic sample to the training dataset in response to a determination that the synthetic sample is one of the subset of synthetic samples. For example, the computing system 101 may add the synthetic sample to the training dataset in response to a determination that the synthetic sample is one of the subset of synthetic samples.

In some embodiments, the synthetic sample is added to the training dataset based on the similarity measure. In some embodiments, the corpus sample is associated with a training label and adding the synthetic sample to the training dataset comprises (i) assigning the training label to the synthetic sample and (ii) storing the synthetic sample and the training label as a supervised training pair within the training dataset. In some embodiments, the training label is one of a negative training label, a positive training label, or a neutral training label. In some embodiments, the corpus sample is one of a set of corpus samples of a corpus training data.

Some techniques of the present disclosure enable the generation of action outputs that may be performed to initiate one or more real world actions to achieve real-world effects. The techniques of the present disclosure may be used, applied, and/or otherwise leveraged to initiate the control of a device, control communication and/or transmission of messages, filter data, and/or the like. In some examples, the synthetic samples of the present disclosure may trigger action outputs (e.g., through control instructions) to automate computer performance actions, such as the display, transmission, and/or the like of data reflective of a machine learning performance, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine learning model”, equivalent terms (e.g., “machine learning model,” “machine-learning model,” “machine learned model,” “machine-learned model,” “machine learning component”, “artificial intelligence”, “artificial intelligence component”), or species thereof (e.g., “a large language model”, “a neural network”) may comprise a single machine learning model or multiple machine learning models, such as a pipeline comprising two or more machine learning models arranged in series and/or parallel, an agentic framework of machine learning models, or the like.

An “artificial intelligence” or “artificial intelligence component” may comprise a machine learning model. A machine learning model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine learning model based at least in part on training hyperparameters (e.g., for supervised, semi-supervised, and reinforcement learning models) and/or by iteratively operating the machine learning model according to the training hyperparameters (e.g., for unsupervised machine learning models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine learning model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine learning model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine learning model comprises may vary depending on the type of machine learning model.

Training hyperparameter(s) may be used as part of training or otherwise determining the machine learning model. In some examples, the training hyperparameter(s), in addition to the training data and/or input data, may affect determining the parameter(s) of the target machine learning model. Using a different set of training hyperparameters to train two machine learning models that have the same architecture (i.e., the same structural hyperparameters) and using the same training data may result in the parameters of the first machine learning model differing from the parameters of the second machine learning model. Despite having the same architecture and having been trained using the same training data, such machine learning models may generate different outputs from each other, given the same input data. Accordingly, accuracy, precision, recall, and/or bias may vary between such machine learning models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine learning model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine learning model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine learning model. The machine learning model may comprise any type of model configured, trained, and/or the like to generate a prediction output for a model input. In some examples, any of the logic, component(s), routines, and/or the like discussed herein may be implemented as a machine learning model.

The machine learning model may comprise one or more of any type of machine learning model comprising one or more supervised, unsupervised, semi-supervised, and/or reinforcement learning models. Training a machine learning model may comprise altering one or more parameters of the machine learning model (e.g., using a loss optimization algorithm) to reduce a loss. Depending on whether the machine learning model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine learning model may comprise executing a set of inference operations executed by the machine learning model according to the target machine learning model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: generating, by one or more processors and using an encoder of a generative machine learning model, a sample text embedding of a corpus sample; generating, by the one or more processors and using a decoder of the generative machine learning model, a synthetic sample based on the sample text embedding of the corpus sample; generating, by the one or more processors and using the encoder, a synthetic text embedding of the synthetic sample; generating, by the one or more processors and using a cost function, a similarity measure for the synthetic sample based on a first comparison between the synthetic text embedding and the sample text embedding; generating, by the one or more processors and using the cost function, a variation measure for the synthetic sample based on a second comparison between the synthetic text embedding and the sample text embedding; and providing, by the one or more processors, a model performance score for the generative machine learning model based on a comparison between the similarity measure and the variation measure.

Example 2. The computer-implemented method of example 1 further comprising adding the synthetic sample to a training dataset based on the similarity measure.

Example 3. The computer-implemented method of example 2, wherein the corpus sample is associated with a training label and adding the synthetic sample to the training dataset comprises: assigning the training label to the synthetic sample; and storing the synthetic sample and the training label as a supervised training pair within the training dataset.

Example 4. The computer-implemented method of example 3, wherein the training label is one of a negative training label, a positive training label, or a neutral training label.

Example 5. The computer-implemented method of example 2, wherein the corpus sample is one of a set of corpus samples of a corpus training data and adding the synthetic sample to the training dataset comprises: generating a set of synthetic samples using one or more corpus samples stochastically sampled from the corpus training data; determining a set of model performance scores that respectively corresponds to the set of synthetic samples; determining a subset of synthetic samples from the set of synthetic samples based on a subset of highest scoring model performance scores from the set of model performance scores; and adding the synthetic sample to the training dataset in response to a determination that the synthetic sample is one of the subset of synthetic samples.

Example 6. The computer-implemented method of example 1 further comprising training the generative machine learning model based on the model performance score.

Example 7. The computer-implemented method of example 6 further comprising determining a reward or a penalty for the generative machine learning model based on the model performance score.

Example 8. The computer-implemented method of example 1, wherein (i) the cost function comprises a genetic fitness function that defines an expectation minimization function, an expectation maximization function, and an aggregate scoring function, (ii) the first comparison comprises applying the expectation minimization function to the synthetic text embedding and the sample text embedding, and (iii) the second comparison comprises applying the expectation maximization function to the synthetic text embedding and the sample text embedding.

Example 9. The computer-implemented method of example 8, wherein the expectation minimization function minimizes a distance between the synthetic text embedding and the sample text embedding.

Example 10. The computer-implemented method of example 8, wherein the expectation maximization function maximizes a gradient between the synthetic text embedding and the sample text embedding.

Example 11. The computer-implemented method of example 10, wherein the gradient between the synthetic text embedding and the sample text embedding is determined at a stochastically sampled point of the synthetic text embedding and the sample text embedding.

Example 12. The computer-implemented method of example 1, wherein the sample text embedding comprises a first distribution of word-level embeddings and the synthetic text embedding comprises a second distribution of word-level embeddings.

Example 13. A system comprising: one or more processors and at least one memory storing processor-executable instructions that, when executed by any of the one or more processors, causes the one or more processors to perform operations comprising: generating, using an encoder of a generative machine learning model, a sample text embedding of a corpus sample; generating, using a decoder of the generative machine learning model, a synthetic sample based on the sample text embedding of the corpus sample; generating, using the encoder, a synthetic text embedding of the synthetic sample; generating, using a cost function, a similarity measure for the synthetic sample based on a first comparison between the synthetic text embedding and the sample text embedding; generating, using the cost function, a variation measure for the synthetic sample based on a second comparison between the synthetic text embedding and the sample text embedding; and providing a model performance score for the generative machine learning model based on a comparison between the similarity measure and the variation measure.

Example 14. The system of example 13, wherein the operations further comprise adding the synthetic sample to a training dataset based on the similarity measure.

Example 15. The system of example 14, wherein the corpus sample is associated with a training label and adding the synthetic sample to the training dataset comprises: assigning the training label to the synthetic sample; and storing the synthetic sample and the training label as a supervised training pair within the training dataset.

Example 16. The system of example 15, wherein the training label is one of a negative training label, a positive training label, or a neutral training label.

Example 17. The system of example 14, wherein the corpus sample is one of a set of corpus samples of a corpus training data and adding the synthetic sample to the training dataset comprises: generating a set of synthetic samples using one or more corpus samples stochastically sampled from the corpus training data; determining a set of model performance scores that respectively corresponds to the set of synthetic samples; determining a subset of synthetic samples from the set of synthetic samples based on a subset of highest scoring model performance scores from the set of model performance scores; and adding the synthetic sample to the training dataset in response to a determination that the synthetic sample is one of the subset of synthetic samples.

Example 18. The system of example 13, wherein the operations further comprise training the generative machine learning model based on the model performance score.

Example 19. The system of example 18, wherein the operations further comprise determining a reward or a penalty for the generative machine learning model based on the model performance score.

Example 20. One or more non-transitory computer-readable storage media including instructions that, when executed by one or more processors, cause the one or more processors to perform operations comprising: generating, using an encoder of a generative machine learning model, a sample text embedding of a corpus sample; generating, using a decoder of the generative machine learning model, a synthetic sample based on the sample text embedding of the corpus sample; generating, using the encoder, a synthetic text embedding of the synthetic sample; generating, using a cost function, a similarity measure for the synthetic sample based on a first comparison between the synthetic text embedding and the sample text embedding; generating, using the cost function, a variation measure for the synthetic sample based on a second comparison between the synthetic text embedding and the sample text embedding; and providing a model performance score for the generative machine learning model based on a comparison between the similarity measure and the variation measure.

Example 21. The computer-implemented method of example 1, wherein the method further comprises training a downstream machine learning model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The system of example 13, wherein the operations further comprise training a downstream machine learning model.

Example 25. The system of example 24, wherein the one or more processors are comprised in a first computing entity; and the downstream machine learning model is trained by one or more other processors comprised in a second computing entity.

Example 26. The one or more non-transitory computer-readable storage media of example 20, wherein the operations further comprise training the downstream machine learning model.

Example 27. The one or more non-transitory computer-readable storage media of example 26, wherein the one or more processors are comprised in a first computing entity; and the downstream machine learning model is trained by one or more other processors comprised in a second computing entity.

1. A computer-implemented method comprising:
generating, by one or more processors and using an encoder of a generative machine learning model, a sample text embedding of a corpus sample;
generating, by the one or more processors and using a decoder of the generative machine learning model, a synthetic sample based on the sample text embedding of the corpus sample;
generating, by the one or more processors and using the encoder, a synthetic text embedding of the synthetic sample;
generating, by the one or more processors and using a cost function, a similarity measure for the synthetic sample based on a first comparison between the synthetic text embedding and the sample text embedding;
generating, by the one or more processors and using the cost function, a variation measure for the synthetic sample based on a second comparison between the synthetic text embedding and the sample text embedding; and
providing, by the one or more processors, a model performance score for the generative machine learning model based on a comparison between the similarity measure and the variation measure.

2. The computer-implemented method of claim 1 further comprising adding the synthetic sample to a training dataset based on the similarity measure.

3. The computer-implemented method of claim 2, wherein the corpus sample is associated with a training label and adding the synthetic sample to the training dataset comprises:
assigning the training label to the synthetic sample; and
storing the synthetic sample and the training label as a supervised training pair within the training dataset.

4. The computer-implemented method of claim 3, wherein the training label is one of a negative training label, a positive training label, or a neutral training label.

5. The computer-implemented method of claim 2, wherein the corpus sample is one of a set of corpus samples of a corpus training data and adding the synthetic sample to the training dataset comprises:
generating a set of synthetic samples using one or more corpus samples stochastically sampled from the corpus training data;
determining a set of model performance scores that respectively corresponds to the set of synthetic samples;
determining a subset of synthetic samples from the set of synthetic samples based on a subset of highest scoring model performance scores from the set of model performance scores; and
adding the synthetic sample to the training dataset in response to a determination that the synthetic sample is one of the subset of synthetic samples.

6. The computer-implemented method of claim 1 further comprising training the generative machine learning model based on the model performance score.

7. The computer-implemented method of claim 6 further comprising determining a reward or a penalty for the generative machine learning model based on the model performance score.

8. The computer-implemented method of claim 1, wherein (i) the cost function comprises a genetic fitness function that defines an expectation minimization function, an expectation maximization function, and an aggregate scoring function, (ii) the first comparison comprises applying the expectation minimization function to the synthetic text embedding and the sample text embedding, and (iii) the second comparison comprises applying the expectation maximization function to the synthetic text embedding and the sample text embedding.

9. The computer-implemented method of claim 8, wherein the expectation minimization function minimizes a distance between the synthetic text embedding and the sample text embedding.

10. The computer-implemented method of claim 8, wherein the expectation maximization function maximizes a gradient between the synthetic text embedding and the sample text embedding.

11. The computer-implemented method of claim 10, wherein the gradient between the synthetic text embedding and the sample text embedding is determined at a stochastically sampled point of the synthetic text embedding and the sample text embedding.

12. The computer-implemented method of claim 1, wherein the sample text embedding comprises a first distribution of word-level embeddings and the synthetic text embedding comprises a second distribution of word-level embeddings.

13. A system comprising:
one or more processors and
at least one memory storing processor-executable instructions that, when executed by any of the one or more processors, causes the one or more processors to perform operations comprising:
generating, using an encoder of a generative machine learning model, a sample text embedding of a corpus sample;
generating, using a decoder of the generative machine learning model, a synthetic sample based on the sample text embedding of the corpus sample;
generating, using the encoder, a synthetic text embedding of the synthetic sample;
generating, using a cost function, a similarity measure for the synthetic sample based on a first comparison between the synthetic text embedding and the sample text embedding;
generating, using the cost function, a variation measure for the synthetic sample based on a second comparison between the synthetic text embedding and the sample text embedding; and
providing a model performance score for the generative machine learning model based on a comparison between the similarity measure and the variation measure.

14. The system of claim 13, wherein the operations further comprise adding the synthetic sample to a training dataset based on the similarity measure.

15. The system of claim 14, wherein the corpus sample is associated with a training label and adding the synthetic sample to the training dataset comprises:
assigning the training label to the synthetic sample; and
storing the synthetic sample and the training label as a supervised training pair within the training dataset.

16. The system of claim 15, wherein the training label is one of a negative training label, a positive training label, or a neutral training label.

17. The system of claim 14, wherein the corpus sample is one of a set of corpus samples of a corpus training data and adding the synthetic sample to the training dataset comprises:
generating a set of synthetic samples using one or more corpus samples stochastically sampled from the corpus training data;
determining a set of model performance scores that respectively corresponds to the set of synthetic samples;
determining a subset of synthetic samples from the set of synthetic samples based on a subset of highest scoring model performance scores from the set of model performance scores; and
adding the synthetic sample to the training dataset in response to a determination that the synthetic sample is one of the subset of synthetic samples.

18. The system of claim 13, wherein the operations further comprise training the generative machine learning model based on the model performance score.

19. The system of claim 18, wherein the operations further comprise determining a reward or a penalty for the generative machine learning model based on the model performance score.

20. One or more non-transitory computer-readable storage media including instructions that, when executed by one or more processors, cause the one or more processors to perform operations comprising:
generating, using an encoder of a generative machine learning model, a sample text embedding of a corpus sample;
generating, using a decoder of the generative machine learning model, a synthetic sample based on the sample text embedding of the corpus sample;
generating, using the encoder, a synthetic text embedding of the synthetic sample;
generating, using a cost function, a similarity measure for the synthetic sample based on a first comparison between the synthetic text embedding and the sample text embedding;
generating, using the cost function, a variation measure for the synthetic sample based on a second comparison between the synthetic text embedding and the sample text embedding; and
providing a model performance score for the generative machine learning model based on a comparison between the similarity measure and the variation measure.
